(19) United States
(12) Patent Application Publication
(10) Pub. No.: US 2004/0165791 A1
(43) Pub. Date: Aug. 26, 2004

(54) Dental image storage and retrieval apparatus

(76) Inventor: Ted Kaltanji, Mississauga (CA)

Correspondence Address: WELSH & KATZ, LTD, 120 S RIVERSIDE PLAZA, 22ND FLOOR, CHICAGO, IL, 60606, US

(21) Appl. No.: 10/371,735

(22) Filed: Feb. 21, 2003

(51) Int. Cl. G06F 17/60; G06K 9/54; G06K 9/60

(52) U.S. Cl. 382/305; 705/3

(57) ABSTRACT

A dental image storage and retrieval apparatus is provided. The apparatus includes one or more client computing devices for displaying and processing dental images. The client devices are connected via a network to a dental image file server. The dental images are stored on the file server using a standardized naming format that allows the dentist to browse through the images without loading an intermediate database management program, making the dental images independent of whatever viewing or editing software program is chosen to actually view or edit the dental images.

### FIELD OF THE INVENTION

The present invention relates to generally to medical imaging in the field of dentistry and more particularly relates to a method and system for storing and manages dental images on a computer or a computer network.

### BACKGROUND OF THE INVENTION

Dentists have long benefited from recorded images of their patient's teeth. For some time now, X-ray technology has provided a straightforward and cost-effective means for dentists to capture images of their patient's teeth. At a minimum, X-ray images are an important diagnostic tool, allowing the dentist to “see inside” the mouth, a single tooth and/or several teeth of the patient. X-ray dental images have a number of other benefits, in that pictures can then be stored in the patient's file for future reference, to allow the dentist to track problems in a patient's teeth over time. X-ray pictures can also be used to show a patient where defects may exist in the patient's teeth, and to help the dentist explain suggested treatments to address those defects.

Dental imaging has come a long way since the X-ray. Digital imaging of dental images is now becoming commonplace. Now dentists can choose to use a variety of imaging devices, such as intra-oral cameras, scanners, digital video and the like to capture images of their patient's teeth. The above-described benefits of X-rays have been improved with these modern imaging devices. Of course, one problem that has arisen in conjunction with the increase in imaging technology is the need for equipment that will effectively manage those images. As the sheer volume of those images increase, enormous strain can be placed on the limited computer resources that are often present in dental offices.

A variety of prior art solutions are available to dentists to assist in managing dental images. One well-known software package that can be used to manage dental images is Vipersoft, by Integra Medical, 727 E. Utah Valley Dr. Ste 500, American Fork, Utah 84003. (http://www.vipersoft.com). Vipersoft is essentially an index based database package (using C TREE database on DentriX software package) that can be used to store, retrieve and otherwise manage a plurality of dental images. In a typical larger-scale dental office, the Vipersoft data file will be stored on a central file server in the administration area of the dental office. This central file server will be connected to a plurality of client machines in the dental operating suites. The client machines in each of the suites will then be able to access the centrally stored data file. However, one problem with the prior art is that, due to the nature of Index databases, any time a dentist needs to access even a single image on the centrally stored data file from a client machine in a dental suite, the entire database is loaded from the central file server to the client machine. This can be an enormous strain on the otherwise limited computing resources of the dental office, straining the bandwidth of the local area network within the dental office, and stressing the CPU and RAM of the local client machine. A further problem with Vipersoft is the proprietary nature of the database file name system, which can require a dentist to undergo an expensive and complicated file conversion should the dentist decide to switch to another dental image storage and retrieval system. Furthermore, a corruption of even a small part of the Vipersoft database index file could result in the loss of an entire collection of dental images.

### SUMMARY OF THE INVENTION

It is therefore an object of the present invention to provide a novel dental image storage and retrieval apparatus that obviates or mitigates at least one of the above-identified disadvantages of the prior art.

In a first aspect of the invention there is provided a method of storing a dental image comprising:

receiving an identity of a patient for whom the dental image is to be stored;

capturing a dental image from the patient's dental region;

generating a unique file name for the image; and,

outputting the image file for storage on a file storage device under the unique file name to identify the image on the file device.

In a particular implementation of the first aspect, the image file is stored as a single file using a native file system of the storage device. The native file system can be any known native file system such as FAT32, NTFS, Macintosh File System, or the Linux File System.

In a particular implementation of the first aspect, the capturing step is performed using an image capture device selected from the group of intra oral cameras, scanners, and X-Rays.

The unique file name can includes a first identifier respective to the patient and a second identifier respective to a dental region captured in the dental image. The selected dental region can be a specific tooth respective to the patient and the second identifier includes a code representing the specific tooth. The unique file name can include another identifier representing the date and/or time when the dental image was captured or created. The unique file name can also include an additional identifier representing the date and/or time when the dental image was modified. The unique file name can also include a fifth identifier representing a type of imaging device used to perform the capturing step.

In a second aspect of the invention, there is provided a method of retrieving a dental image comprising:

receiving an identity of a patient;

retrieving at least a portion of dental images respective to the patient from a storage device that are stored under a native file system of the storage device according to the identity;

presenting a plurality of the retrieved dental images to a user for browsing;

retrieving a dental image for processing when the user selects one of the presented dental images; and

identifying a next portion of the images from the storage device when the user declines to select one of the presented dental images; and

repeating the presenting, retrieving the dental image and identifying steps until a criteria is established for terminating the method.

In a third aspect of the invention, there is provided a system for storing and retrieving dental images comprising a dental image file server for storing a plurality of dental images. The dental images are stored on the file system using a unique file name for each image. The file server is connected to at least one dental image client that is for delivering dental images to the server in order to store the images on the server. The dental image client is also operable to retrieve dental images from the dental image file server. A dental image input device, such as an intra-oral camera or the like, is connected to the client for receiving a captured dental image from a patient. A dental image output device is connected to the client for presenting the dental images to a user, such as a dentist.

### BRIEF DESCRIPTION OF THE DRAWINGS

The present invention will now be explained, by way of example only, with reference to certain embodiments and the attached Figures in which:

FIG. 1 is a schematic representation of a dental image storage and retrieval system in accordance with an embodiment of the invention;

FIG. 2 is a schematic representation of the RAID storage device of FIG. 1;

FIG. 3 is a flow-chart of a method for storing dental images in accordance with another embodiment of the invention; and,

FIG. 4 is a flow-chart of a method for retrieving dental images in accordance with another embodiment of the invention.

### DETAILED DESCRIPTION OF THE INVENTION

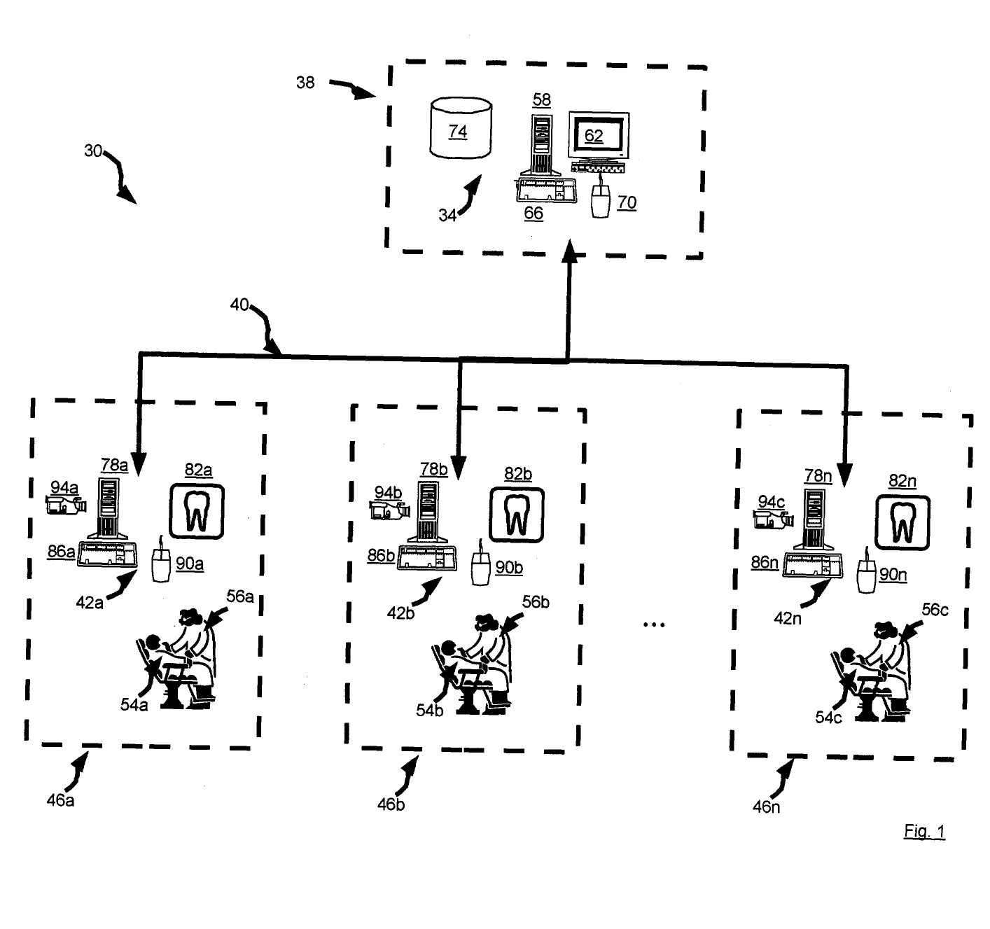

Referring now to FIG. 1, a dental image storage and retrieval system is indicated generally at 30. System 30 includes a dental image file server 34 in a server room 38, located in, or otherwise connected to, a dental office. File server 34 is connected via a network 40 to a plurality of dental image clients 42 (shown on FIG. 1 as clients 42a, 42b . . . 42n) which are each located in their own dental operating suite 46 (shown on FIG. 1 as suites 46a, 46b . . . 46n) located within the dental office. Clients 42 are typically ergonomically accessible to a patient 54 and/or a dentist 56, when they are located within the suite 46, so that the dentist 56 can operate on the client 42, and/or the patient 54 can view information displayed by the client 42.

Dental image file server 34 comprises a CPU tower 58 that interconnects a monitor 62 (and/or other output devices), a keyboard 66, a mouse 70 (and/or other input devices), and a redundant array of inexpensive discs 74 or RAID 74 (and/or other storage devices). Tower 58 further includes a network interface card (or other network interface means) for managing incoming and outgoing communications with clients 42. As will be explained in greater detail below, RAID 74 stores a plurality of dental images that can be accessed by clients 42 via network 40. Thus, the size of RAID 74 will typically depend on the number of images that the particular dental offices wishes to maintain. Further details about RAID 74 will be discussed in greater detail below.

The hardware and protocol to implement network 40 is not particularly limited, and can include an Ethernet local area network, a wide area network, and 802.11b wireless network, the Internet, an intranet or the like.

Dental image clients 42 comprise a CPU tower 78 that interconnects a monitor 82 (and/or other output devices), a keyboard 86, a mouse 90, an intra-oral camera 94 (and/or other input devices). Tower 78 further includes a network interface card (or other network interface means) for managing incoming and outgoing communications with server 34 via network 40. In general terms, client 42 is operable to retrieve images stored on RAID 74 and present such retrieved images on monitor 82. Similarly, client 42 is operable to capture dental images of patient 54 using intra-oral camera 94 and send those images to server 34 for storage on, and later retrieval from, RAID 74.

The file system used to store dental image files on RAID 74 is based on the chosen or native operating system used to operate server 34. For example, where the operating system for server 34 is Microsoft WindowsXP, then the file storage system used to store dental image files on RAID 74 can based on FAT32 (i.e. File Allocation Table that supports partitions larger than two gigabytes and pathnames greater that 256 characters.) or NTFS (i.e. NT File System, the native file system of Windows NT). Other file systems will occur to those of skill in the art, such as the Macintosh file system or Linux file system. In general, it is presently preferred that the images stored on RAID 74, regardless of their file type (e.g. TIFF, JPEG, MPEG, PCX etc.) are stored as atomic files according to the file system of RAID 74.

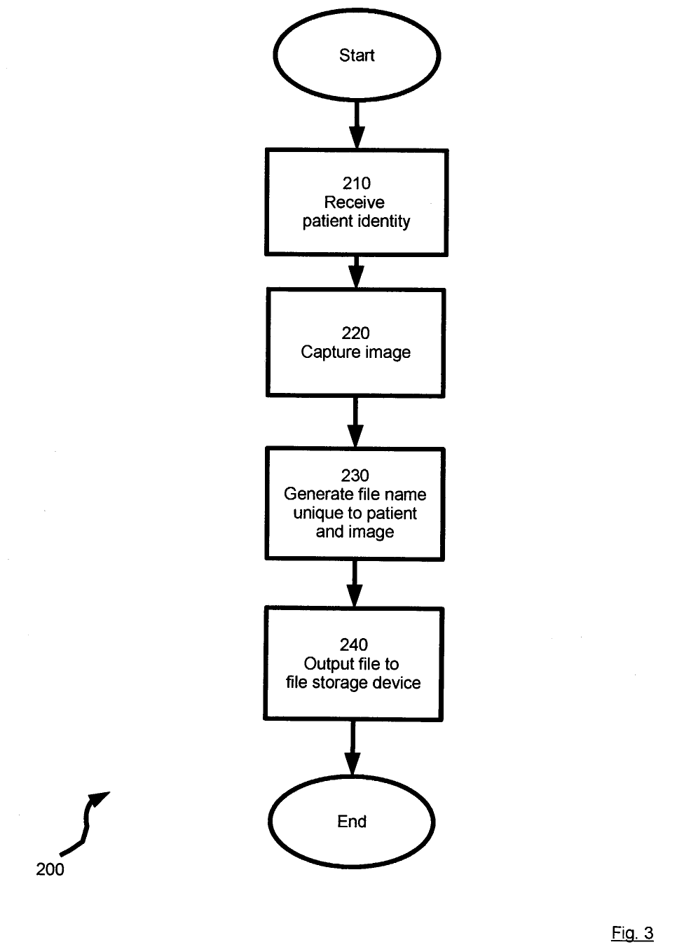

Referring now to FIG. 3, a tree diagram of a file structure of RAID 74 is indicated at 100. In a present embodiment, file structure 100 is based on NTFS, and includes a parent directory 104 and a plurality of sub-directories 108 thereunder. Parent directory 104 can either be the root directory of RAID 74, or it can be a directory, or sub-directory thereunder as desired. In any event, it is presently preferred that, wherever parent directory 104 is located on RAID 74, parent directory 104 should be reserved for storing sub-directories 108 that are for storing a plurality of dental image files 110.

Sub-directories 108 are created and then reserved for individual patients 54 of the dental office associated with system 30. Thus, the directory name format of each sub-directory 108 will include a unique patient identifier 112 for that particular patient 54, which can include any number of indicia such as the patient's name, social security number, and/or a unique file number assigned by the dental office, and/or a combination thereof. Whichever indicia or indicium are used for the identifier, it is presently preferred that a consistent format be used, based on accepted characters for the file system (in this case NTFS) used for RAID 74. Where multiple indicia are used, it is presently preferred that such indicia are delimited as separate fields by using particular reserved characters, such as hyphens “-”, or underscores “_”, and that such reserved characters are omitted from use in the actual indicia themselves. In this manner, the directory name can be parsed due using its known name format, and the dental image directories therein searched and utilized, by individuals manually accessing RAID 74 (either through server 34 or through clients 42), or by software packages that may automatically search or otherwise utilize dental image directories of RAID 74 according to its NTFS file structure. In order to more consistently achieve the desired consistent directory name format, it is presently preferred, but not required, that such directory names on RAID 74 be automatically created by software executing on server 34 or client 42, rather than by manually creation of such directory names.

An exemplary naming format for patient identifier 112 is of the format shown in Table I:

TABLE I
Directory Naming Format
SURNAME-Given_name-Patient_number

As can be seen by examining this format, it contains three text fields, each delimited by a hyphen “-”. The first text field, SURNAME means the last name, or family name of the patient, and is typed in capital letters. The second text field, Given_name, means the patient's given name, typed in lower-case letters but with an initial capital letter for the given name. The third field, Patient_number, is a unique number assigned to that patient by the dental office, which can be helpful to distinguish patients having identical surnames and given names.

Dental image files 110 of a particular patient 54 are thus stored under the sub-directory 108 created for that particular patient. The file name format of each dental image file 1110 will typically include a number of indicia such as a patient identifier, a file creation date, a file creation time, a modification date, a description of the source from which the image was derived, and an image description. Also, as typically found in the NTFS file system, and the like, the image file name will also include a file type, which is typically indicated by the final three (or more) characters of the file name, preceded by a period or “.”. (i.e. X.tif, X.jpg, X.pcx, X.gif etc., where X is the remainder of the file name.) social security number, and/or a unique file number assigned by the dental office, and/or a combination thereof. Whichever indicia for the file name is used, it is presently preferred that a consistent format be used, based on accepted characters for the file system (in this case NTFS) used for RAID 74. It is presently preferred that such indicia are delimited as separate fields by using particular reserved characters, such as hypens “-”., or underscores “_”, and that such reserved characters are omitted from use in the actual indicia themselves. In this manner, the file name can be parsed using its known file name format, and the dental images therein searched and utilized, by individuals manually accessing RAID 74 (either through server 34 or through clients 42), or by software packages that may automatically search or otherwise utilize dental images stored on RAID 74 according to the NTFS file structure. In order to more consistently achieve the desired consistent file name format, it is presently preferred, but not required, that such file names on RAID 74 be automatically created by software executing on server 34 or client 42, rather than by manually creation of such file names.

An exemplary file naming format for dental image 110 is of the format shown in Table II:

TABLE II
Filing Naming Format
SURNAME-Creation_date-Creation_time-Modification_date-
Image_Source-Image_identification

As can be seen by examining this format, it contains six text fields, each delimited by a hyphen “-”. The first text field, SURNAME is the last name, or family name of the patient, and is typed in capital letters, and is common with the SURNAME found in the name of the sub-directory 108 where the image resides. The second text field, Creation_date, is the date on which the image file was actually created, and will typically correspond with the day that the image was obtained from the patient. By the same token, the third field, Creation_time, is the time of the day on which the image file was created. Modification_date means a date on which the image was accessed and modified. While a record of file modification can also be seen in the modification information inherent to NTFS, it is presently preferred to hard-code this information into the file name, so that multiple modifications of the image file can be retained on RAID 70, and/or to distinguish from system maintenance modifications to the file, such as might occur during back-up procedures of RAID 70 and/or to allow for transport of such information should images be moved to another storage device based on another file system other than NTFS. Image_Source refers to the particular device used to obtain the dental image, which could be comprised of codes such as, for example, “IOC” to refer to intra-oral camera 94, or “SCA” to mean a scanned image of an X-ray. Other types of image sources will occur to those of skill in the art. Finally, the Image_identification is used to identify the actual image, and is typically comprised of a unique code common in the dental profession, such codes being used to identify a particular tooth, or set of teeth and/or the angle from which such images were taken. However, the particular structure of information used in Image_identification is not particularly limited.

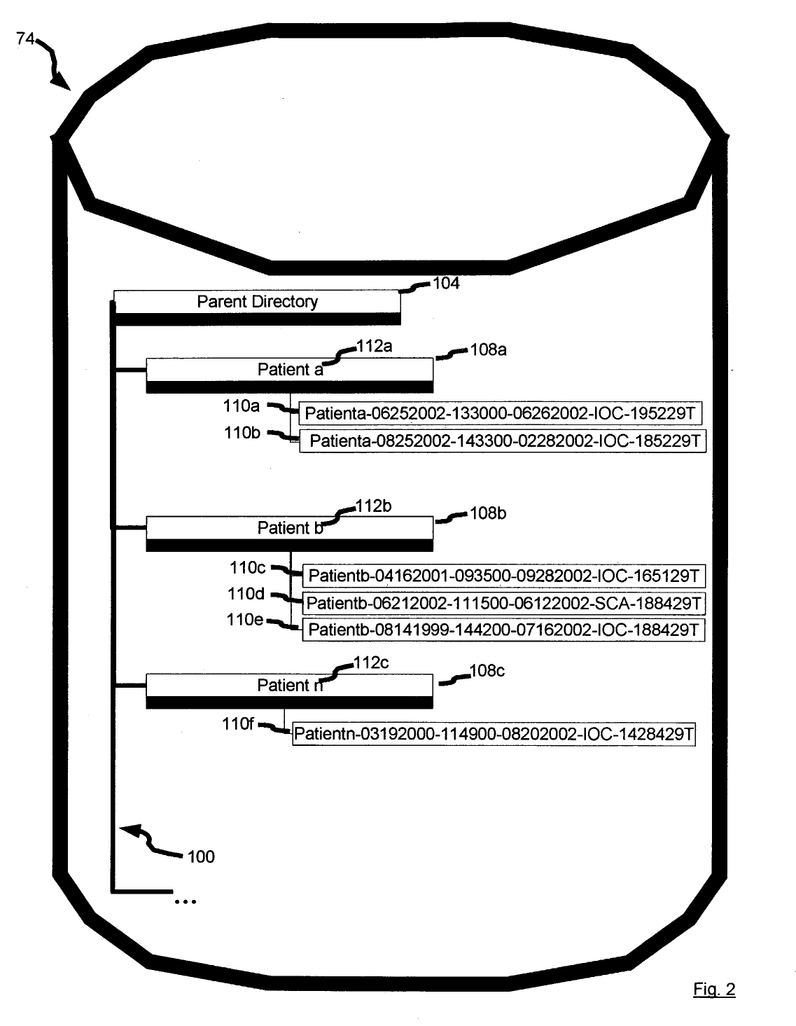

Referring now to FIG. 3, a method for storing dental images is indicated generally at 200. In order to assist in the explanation of method 200, it will be assumed that method 100 is performed using system 30. It is to be understood that the following discussion of method 200 will lead to further understanding of system 30. (However, it is to be further understood that system 30 and/or method 200 can be varied, and/or that method 200 need not be performed according the exact sequence shown in FIG. 2, and/or that system 30 and method 200 need not work exactly as discussed herein in conjunction with each other, and that such variations are within the scope of the present invention.)

At step 210, the identity of the patient is received. When implemented on system 30, this step can be implemented a number of ways. For example, when a patient 54 becomes a patient of the dental office associated with system 30, during the collection of his initial intake data, his identity can be entered into file server 34, and as part of creating a database record on server 34 for patient 54, a sub-directory 108 created for that particular patient 54 according to the above-described format. Another way step 210 can be implemented is directly by a dentist 56 (or other dental professional) manually inputting the data who is working with a patient 54 using a client 42 in the suite 46 where the dentist 56 and patient 54 are located. Other ways of receiving the identity of patient 54 will now occur to those of skill in the art. For purposes of explaining method 200, it will be assumed that sub-directory 108a shown on FIG. 2 for patient 54a in suite 46a was created on RAID 74 on some previous date when patient 54a became a patient of the dental office associated with system 30. Thus, the step of receiving the identity of patient 54a will be assumed to occur on client 42a, through the act of dentist 56a selecting patient 54a's name from a menu of names of existing patients 54 belonging to the dentist office associated with system 30.

At step 220, a image of a dental feature of the patient is captured. When using system 30, using the example of patient 54a in suite 46a, this step can be implemented by dentists 56a directing intraoral camera 94a towards a specific location in the mouth of patient 54a, and activating camera 94a to collect the desired image. Having activated camera 94a the image is transferred to CPU tower 78a. (Step 220 can be implemented in other ways however, depending on the type of image capture equipment available on system 30.)

Next, at step 230 a file name unique to the patient and the captured image is generated. When implemented on system 30 using the example of patient 54a in suite 46a, it is contemplated that CPU tower 78a will execute software that will create a file name for the captured image according to the format shown in Table II.

Filing Naming Format
SURNAME-Creation_date-Creation_time-Modification_date-
Image_Source-Image_identification

When CPU tower 78a generates this file name, it will assemble the SURNAME from the SURNAME of patient 54a as obtained at step 210, it will assemble the Creation_date and Creation_time from the system clock of CPU tower 78a, and it will use the code “IOC”, to represent intra-oral camaera 94a, which tower 78a will inherently know as being the source to capture the image at step 220. The final field, “Image_Identification”, will be manually inputted by dentist 56a, based on a prompt generated by tower 78a. Dentist 56a will effect such manual input by either by typing in the information using keyboard 86a, or using mouse 90a to select a predefined code from a menu offered by tower 78a via display 82a.

At step 240, the captured image will be outputted for storage on a file storage device under the name generated at step 230. When step 240 is implemented on system 30 according to the foregoing example, CPU tower 78a will attach the file name generated at step 230 to the image captured at step 220, and, using the network protocols of network 40, deliver the image and the file name to file server 34, which in turn will save the image on RAID 74 under sub-directory 108a.

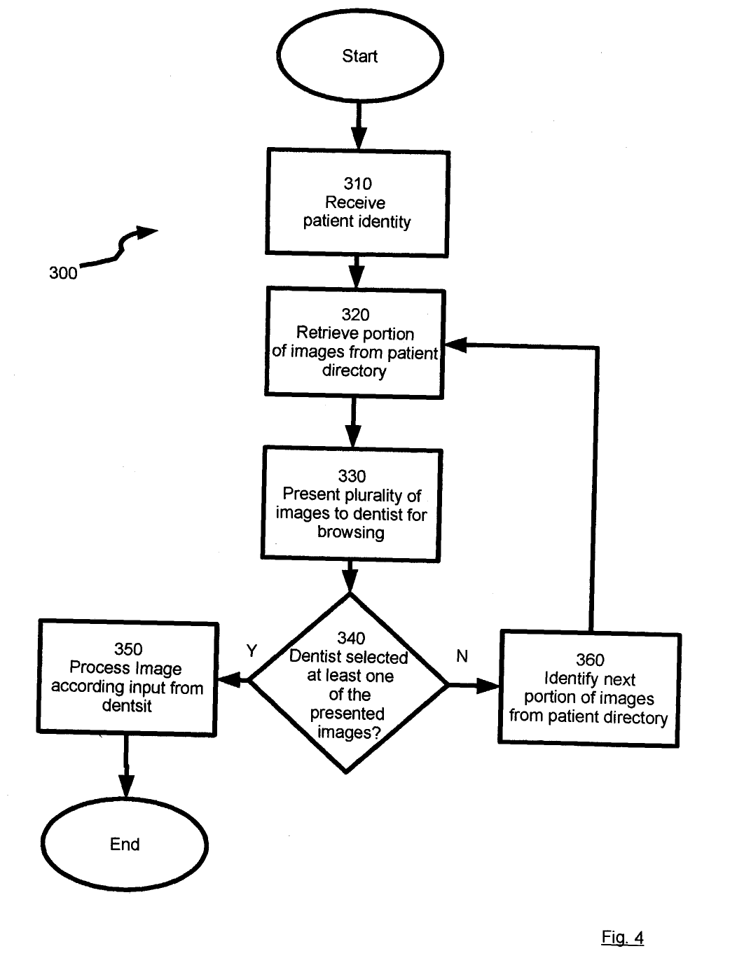

Referring now to FIG. 4, a method for retrieving one or more dental image in accordance with another embodiment of the invention is indicated generally at 300. Prior to execution of this method, it is assumed that the particular patient is already a patient of the dental office associated with system 30, and that a directory 108 containing dental images of that patient is stored on RAID 74 in accordance with file structure 100—such images having been stored using method 200 or the like. Beginning at step 310, the identity of the patient is received. When implemented on system 30, this step can be implemented a number of ways, however, in one example it is assumed that patient 54a is in dental suite 46a, and that dentist 56a enters in the name of patient 54a into keyboard 86a, and this input is received by tower 78a.

Next, at step 320 at least a portion of the dental images of the identified patient are retrieved from the directory associated with that patient. When implemented on system 30 according to the assumptions made above, tower 78a will send an instruction to server 34 to access directory 108a associated with patient 54a. A predefined number of images stored in directory 108a will then be downloaded over network 40 to tower 78a. The number of images that comprise the portion that are retrieved can depend on a number of factors. For example, where the directory 108a contains only one image, then the portion will be simply that one image. Where there are multiple images in directory 108a, then it is presently preferred to only retrieve only those number of images that can be presented as a plurality of thumbnail on display 82a, of a size that dentist 56a can make use of the thumbnail to determine which image or images the dentist 54a ultimately wishes to work with. Another criteria that can be used to determine what portion of directory 108a to download is based on the bandwidth capacity of network 40, and/or other hardware resources of system 30. For example, where multiple dentists 56 are attempting to simultaneously execute method 300 on system 30, it can be desired to limit the portion of images that are downloaded as a portion of directory 108a, so as to reduce waiting times for each dentist. Other hardware constraints of system 30 can also used as criteria to determine how many images are retrieved at a given time from RAID 74 to a given client 42.

At step 330, the portion of images retrieved at step 320 are presented to the dentist. Continuing with the above example, when using system 30 the images are presented on display 82a, typically as a plurality of thumbnails all on a single screen. The dentist 56a can then use mouse 90a to browse through, and/or select one or more of the presented images.

Next at step 340, a determination is made of which browsing instruction was received at step 330 by the dentist. If it is determined that the dentist selected one of the dental images that was presented at step 330, then the method advances to step 350 where the dental image is processed according to input received from the dentist. Such processing can include, magnifying, cutting portions therefrom, marking, highlighting or other editing functions as desired. Those of skill in the art will appreciate that at this step 340, the dentist 56a has the opportunity to show the dental image, such as a particular tooth, of patient 54a, and to discuss with patient 54a possible corrective steps that may be taken with that particular tooth. In method 300, once the dentist 56a finishes processing the image, the method ends, but the method could simply begin a new again at 210 in order to retrieve another image, or simply return to step 330 in order to retrieve another image of that patient 54a. In general, it now be understood by those of skill in the art that known or future dental image processing software can be used at step 350, thereby making the database of images stored on RAID 74 independent of such dental image processing software, allowing the dentist the opportunity to upgrade or change to different operating systems or dental imaging software programs without the need to convert the database of images on RAID 74 into a format understandable to the different dental image processing software.

However, if it is determined at step 340 that the dentist did not select any particular image presented at step 330, but instead wishes look at other images stored on RAID 74, then the method advances to step 360 where another portion of images from the patient directory (in this example directory 108a) are identified, and the method returns to step 220, at which point that another portion of images are retrieved as previously described.

While only specific combinations of the various features and components of the present invention have been discussed herein, it will be apparent to those of skill in the art that desired subsets of the disclosed features and components and/or alternative combinations of these features and components can be utilized, as desired. For example, it is to be understood that the particular suggested formats for patient identifier 112 and dental image 110 are merely exemplary, and that other formats can be used as desired.

The above-described embodiments of the invention are intended to be examples of the present invention and alterations and modifications may be effected thereto, by those of skill in the art, without departing from the scope of the invention which is defined solely by the claims appended hereto.

1. A method of storing a dental image comprising:
receiving an identity of a patient for whom said dental image is to be stored;
capturing a dental image from said patient's dental region;
generating a unique file name for said image; and,
outputting said image file for storage on a file storage device under said unique file name to identify said image on said file device.

2. The method according to claim 1 wherein said image file is stored as a single file using a native file system of said storage device.

3. The method according to claim 1 wherein said native file system is selected from the group consisting of FAT32, NTFS, Macintosh File System, and Linux File System.

4. The method according to claim 1 wherein said capturing step is performed using an image capture device selected from the group of intra oral cameras, scanners, and X-Rays.

5. The method according to claim 1 wherein said unique file name includes a first identifier respective to said patient and a second identifier respective to a dental region captured in said dental image.

6. The method according to claim 5 wherein said dental region is a specific tooth respective to said patient and said second identifier includes a code representing said specific tooth.

7. The method according to claim 5 wherein said unique file name includes a third identifier representing at least one of a date and time when said dental image was captured or created.

8. The method according to claim 5 wherein said unique file name includes a fourth identifier representing when said dental image was modified.

9. The method according to claim 5 wherein said unique file name includes a fifth identifier representing a type of imaging device used to perform said capturing step.

10. A method of retrieving a dental image comprising:
receiving an identity of a patient;
retrieving at least a portion of dental images respective to said patient from a storage device that are stored under a native file system of said storage device according to said identity;
presenting a plurality of said retrieved dental images to a user for browsing;
retrieving a dental image for processing when said user selects one of said presented dental images; and
identifying a next portion of said images from said storage device when said user declines to select one of said presented dental images; and
repeating said presenting, retrieving said dental image and identifying steps until a criteria is established for terminating said method.

11. A system for storing and retrieving dental images comprising:
a dental image file server for storing a plurality of dental images thereon according to a unique file name for each one of said images;
at least one dental image client connected to said dental image file server for delivering dental images to said server for storage thereon and for retrieving dental images therefrom;
a dental image input device connected to said client for receiving a captured dental image from a patient; and,
a dental image output device connected to said for presenting said dental images to a user.

12. The system according to claim 11 wherein each of said image files are stored as a single file using a native file system of said storage device.

13. The system according to claim 11 wherein said native file system is selected from the group consisting of FAT32, NTFS, Macintosh File System, and Linux File System.

14. The system according to claim 11 wherein said a dental image input device is selected from the group of intra oral cameras, scanners, and X-Rays.

15. The system according to claim 11 said unique file name includes a first identifier respective to said patient and a second identifier respective to a dental region captured in said dental image.

16. The system according to claim 15 said dental region is a specific tooth respective to said patient and said second identifier includes a code representing said specific tooth.

17. The system according to claim 11 wherein said unique file name includes a third identifier representing at least one of a date and time when said dental image was captured or created.

18. The system according to claim 15 wherein said unique file name includes a fourth identifier representing when said dental image was modified.

19. The system according to claim 15 wherein said unique file name includes a fifth identifier representing a type of said dental image input device.
